(19) United States
(12) Patent Application Publication
(10) Pub. No.: US 2025/0031731 A1
(43) Pub. Date: Jan. 30, 2025

(54) CRISPY BANANA SNACK PRODUCTS

(71) Applicant: EnWave Corporation, Delta (CA)

(72) Inventors: Guopeng Zhang, Delta (CA); Erika Sandoval, Delta (CA); Shafique Ahmad, Delta (CA); Braden Knights, Delta (CA)

(21) Appl. No.: 18/713,066

(22) PCT Filed: Jan. 19, 2022
(86) PCT No.: PCT/CA2022/050076

§ 371 Date: May 23, 2024

(51) Int. Cl. A23L 19/00; A23P 30/38

(52) U.S. Cl. CPC A23L 19/09; A23P 30/38

(57) ABSTRACT

A porous, crunchy dried banana food product is made by mixing a ripe banana puree and either ripe or unripe banana flour to form a composition, and exposing the composition to microwave radiation at a pressure less than atmospheric to puff and dry the composition, producing the porous, crunchy dried banana food product. The method enables a food product based on banana puree to be dried to a porous, crunchy snack product by means of microwave vacuum drying without requiring non-banana thickeners.

### FIELD OF THE INVENTION

The invention pertains to methods of making porous, crunchy dried banana food products using microwave vacuum drying.

### BACKGROUND OF THE INVENTION

It is known in the food processing art to make dehydrated food products by means of microwave vacuum drying. Examples are disclosed in WO 2014/085897 for the production of dehydrated cheese pieces, and U.S. Pat. No. 6,312,745 for the production of dehydrated and puffed berries.

It is also known to make dehydrated food products comprising dried purees of some fruits and vegetables, using various thickeners to increase the viscosity of the puree prior to drying. See US 2018/0160708 (Eisner), WO 2014/118183 (Lock et al.), U.S. Pat. No. 8,192,784 (Anand et al.), and WO 2009/022298 (Bunke et al.).

Bananas are a popular and nutritious tropical fruit. Banana puree alone cannot be dried to a crispy texture by microwave vacuum drying. It would be desirable to provide a dried snack product from bananas alone, without admixture with non-banana thickeners. The present disclosure is directed to such products and to methods for making them.

### SUMMARY OF THE INVENTION

One aspect of the invention provides methods for making a porous, crunchy dried banana food product, comprising: (a) providing a banana puree; (b) providing banana flour; (c) mixing the puree and the flour to form a composition; and (d) exposing the composition to microwave radiation at a pressure less than atmospheric to puff and dry the composition, producing the porous, crunchy dried banana food product.

Another aspect of the invention provides a porous, crunchy dried banana food product, comprising dried banana puree and banana flour.

In some embodiments, the banana flour is unripe banana flour; in other embodiments, the banana flour is ripe banana flour.

Further aspects of the invention and features of specific embodiments of the invention are described below.

### BRIEF DESCRIPTION OF THE DRAWINGS

FIG. 1 is a photo of a dried banana snack product made in accordance with the procedure of Example 1.

FIG. 2 is a photo of a dried banana snack product made in accordance with the procedure of Example 2.

### DETAILED DESCRIPTION

The present inventors have discovered that banana flour can be mixed with banana puree to produce a composition that can be dried to a crispy, porous texture by microwave vacuum drying.

In this disclosure, “unripe banana flour” means a flour produced from the pulp of unripe bananas, commonly referred to as “green bananas.” “Ripe banana flour” means a flour produced from the pulp of ripe, yellow bananas. “Banana puree” means a puree produced from the pulp of ripe, yellow bananas. “Banana” means the kinds of that fruit that have a yellow peel when ripe and a green peel when unripe.

In some embodiments, the banana flour that is used is unripe banana flour. Unripe (green) banana is not commonly consumed raw, but its flour is known as a dry food ingredient. It is rich in resistant starch, dietary fibers, polyphenols, potassium, vitamin B6, gamma aminobutyric acid and tryptophan. The dried banana products of the present invention are made using banana puree and either unripe banana flour or ripe banana flour. No other ingredients are required, though some optional ingredients can be added.

These optional ingredients include: natural or artificial flavourings, such as vanilla extract; nut pieces; chocolate chips; coconut flakes; fruit pieces; natural or artificial sweeteners; proteins such as milk protein, whey protein and sunflower protein; fats; and oils. The optional ingredients may be present in an amount in the range of 0.1 to 25 wt. % of the composition.

The banana puree can be prepared by peeling ripe bananas, mashing the pulp and pureeing it using a food blender. Banana puree is also available as a commercial product, and such products may be used.

Unripe banana flour can be prepared by peeling green bananas, drying the pulp, and milling the dried pulp to a flour. Unripe banana flour is also available as a commercial product, marketed as green banana flour, and such products may be used.

Ripe banana flour can be prepared by peeling ripe bananas, drying the pulp, and milling the dried pulp to a flour.

The banana puree and banana flour, either unripe banana flour or ripe banana flour, are mixed together thoroughly, for example using a food blender. The proportion of banana puree may be in the range of 50 to 95 wt. %. The proportion of banana flour may be in the range to 5 to 50 wt. %. The moisture content of the resulting composition may be in the range of 35 to 75 wt. %, or 50 to75 wt. % The moisture content may be affected by the added optional ingredients, if any. The composition is in the form of a spreadable paste or batter. It may be spread on trays in a relatively thin layer, e.g., 10 to 20 mm. It may also be put in molds to give it a desired shape. The composition is then dried to a crisp or crunchy, porous product by means of microwave vacuum drying.

Methods and apparatus for microwave vacuum drying of food products are known in the art. An example of a microwave vacuum dehydrator that can be used for drying the banana compositions is shown in WO 2011/085467 and is marketed by EnWave Corporation of Delta, BC, Canada under the trademark quantaREV. Using this type of apparatus, trays of the banana composition are fed into a vacuum chamber and conveyed across a microwave-transparent window on a conveyor belt while being subjected to drying by means of low pressure and microwave radiation. Examples of absolute pressures suitable for processing the banana compositions are in the range of about 0.1 to 100 Torr (0.01 to 13.3 kPa), alternatively 1 to 100 (0.13 to 13.3 kPa), alternatively 10 to 100 (1.33 to 13.3 kPa), alternatively 3 to 30 Torr (0.4 to 4.0 kPa). The microwave generator is actuated to radiate microwaves in the vacuum chamber.

During the microwave vacuum drying step the banana composition is dried and expanded as water vapor is evaporated from it, and the expanded structure of the product is fixed. Examples of suitable drying times are in the range of 15 to 60 minutes. Once sufficient drying has occurred, for example to a moisture level less than 5 wt. %, the radiation is stopped, the pressure in the vacuum chamber is equalized with the atmosphere, and the dried, porous banana food product is removed from the microwave vacuum dehydrator. The dried food product may comprise about 17 to 80 wt. % banana flour.

It will be understood that references to “drying” in this disclosure mean that the moisture level is reduced to a desired level, not necessarily to zero.

The step of microwave vacuum drying may optionally be conducted in two or more stages having different conditions in order to optimize the drying conditions and quality of the product. For example, in a first stage, the microwave power level may be higher than in a second stage, or the converse.

### EXAMPLES

### Example 1

A mixture was prepared comprising 89.8 wt. % banana puree, 10 wt. % unripe banana flour, and 0.2 wt. % vanilla extract. The banana puree was CHIQUITA brand, having 0.03% ascorbic acid, acidity 0.3-0.5% as citric acid, and Brix 21-25. The unripe banana flour was NuBana brand green banana flour, product code N100. The vanilla extract was CLUB HOUSE brand artificial vanilla extract. The puree, the unripe banana flour and the vanilla extract were mixed using a NINJA Mixer blender (Express Chop) for 30 seconds. The resulting composition was poured onto a tray lined with parchment paper and was spread homogeneously in a single layer using a spatula.

Drying of the banana composition was done using a travelling wave laboratory-scale EnWave quantaREV microwave vacuum dryer. The sample load was 238.2 g, having an initial moisture content of 69.86 wt. %. Absolute pressure was maintained in the range of 23 to 27 Torr (3.07 to 3.6 kPa). The microwave power level was 2 kW (4 magnetrons at 500 W each). Microwave vacuum treatment was carried out for an initial period of 37 minutes, during which the product temperature was measured at 93° C. The sample was then removed from the dehydrator and weighed. The sample was then subjected to further microwave vacuum treatment for 10 minutes, during which the product temperature was measured at 95° C. The microwave power was then stopped and the product was allowed to cool down under vacuum for about 10 minutes, to a temperature of about 90° C., and was removed from the dehydrator.

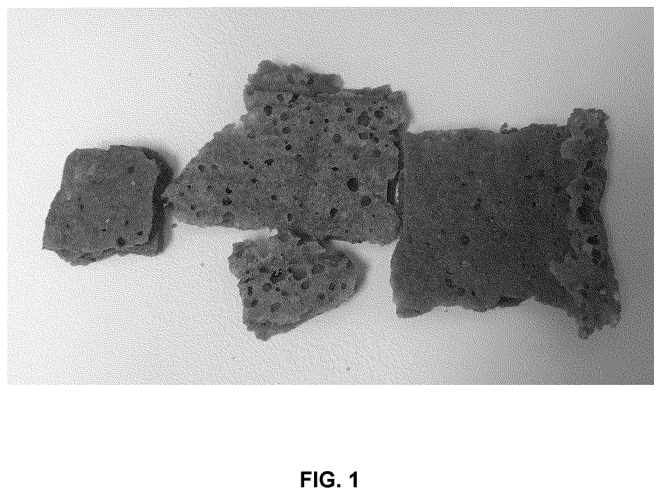

The weight of the dried food product was 73.6 g. It was determined that the water loss during drying was 164.6 g. The total microwave energy applied during the process was 1.79804 kWh. The dried food product was porous and crunchy. It is shown in the photo of FIG. 1.

### Example 2

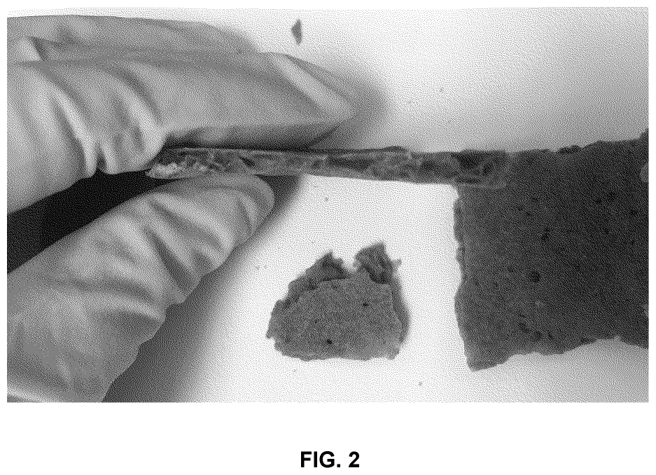

A dried food product was prepared in accordance with the procedure of Example 1, except that the proportion of unripe banana flour in the mixture was 15 wt. % (rather than 10 wt. % as in Example 1). The dried food product, shown in the photo of FIG. 2, was found to be harder than the product of Example 1. This demonstrates that the hardness of the dried banana snack product can be controlled by varying the proportion of unripe banana flour.

### Example 3

A dried food product was prepared in accordance with the procedure of Example 1, except that the banana flour used was ripe banana flour instead of unripe banana flour. The dried product was similar to the product of Example 1, with a porous and brittle texture.

As will be apparent to those skilled in the art in the light of the foregoing disclosure, many alterations and modifications are possible in the practice of this invention without departing from the scope thereof. Accordingly, the scope of the invention is to be construed in accordance with the following claims.

What is claimed is:

1. A method of making a porous, crunchy dried banana food product, comprising:
(a) providing a banana puree;
(b) providing banana flour;
(c) mixing the puree and the banana flour to form a composition;
(d) exposing the composition to microwave radiation at a pressure less than atmospheric to puff and dry the composition, producing the porous, crunchy dried banana food product.

2. The method of claim 1, wherein the banana flour comprises unripe banana flour.

3. The method of claim 1, wherein the banana flour comprises ripe banana flour.

4. The method of claim 1, wherein the composition comprises from 50 to 95 wt. % of the banana puree.

5. The method of claim 1, wherein the composition comprises from 5 to 50 wt. % of the banana flour.

6. The method of claim 1, wherein the composition formed in step (c) further comprises one or more ingredients selected from the group consisting of natural flavourings, artificial flavourings, nut pieces, chocolate chips, coconut flakes, fruit pieces, natural sweeteners, artificial sweeteners, milk protein, whey protein, sunflower protein, fats and oils.

7. The method of claim 6, wherein the composition formed in step (c) comprises from 0.1 to 25 wt. % of said one or more ingredients

8. The method of claim 1, wherein the composition prepared in step (c) has a moisture content in the range of 35 to 75 wt. %.

9. The method of claim 1, wherein the pressure in step (d) is in the range of 0.1 to 100 Torr (0.01 to 13.3 kPa).

10. The method of claim 1, wherein step (d) dries the composition to a moisture content of less than 5 wt. %.

11. The method of claim 1, wherein step (d) is done for a time period in the range of 15 to 60 minutes.

12. The method of claim 1, wherein step (d) is done in at least two stages and a microwave power level in each stage is different.

13. A porous, crunchy dried banana food product, comprising dried banana puree and banana flour.

14. The dried banana food product of claim 13, wherein the banana flour comprises green banana flour.

15. The dried banana food product of claim 14, wherein the banana flour comprises yellow banana flour.

16. The dried banana food product of claim 13, wherein the dried food product comprises from 17 to 80 wt. % of banana flour.

17. The dried banana food product of claim 13, further comprising one or more ingredients selected from the group consisting of natural flavourings, artificial flavourings, nut pieces, chocolate chips, coconut flakes, fruit pieces, natural sweeteners, artificial sweeteners, milk protein, whey protein, sunflower protein, fats and oils.
